(19) United States
(12) Patent Application Publication
(10) Pub. No.: US 2018/0052295 A1
(43) Pub. Date: Feb. 22, 2018

(54) OPTICAL FIBER DISTRIBUTION

(71) Applicant: HEWLETT PACKARD ENTERPRISE DEVELOPMENT LP, Houston, TX (US)

(72) Inventors: Terrel MORRIS, Plano, TX (US); Raymond G. BEAUSOLEIL, Palo Alto, CA (US)

(21) Appl. No.: 15/555,023

(22) PCT Filed: Mar. 27, 2015
(86) PCT No.: PCT/US2015/022936

§ 371 Date: Aug. 31, 2017

(51) Int. Cl. G02B 6/44

(52) U.S. Cl. CPC G02B 6/4471; G02B 6/4452

(57) ABSTRACT

In examples provided herein, an optical fiber distribution node comprises a housing assembly that has an input port in the housing assembly and an input optical fiber cable coupled to the input port. The input port comprises multiple optical fibers. A first subset of the optical fibers is routed from the input port through a first output port in the housing assembly, and a second subset of the optical fibers is routed from the input port through a second output port.

### BACKGROUND

Optical fibers can transmit data in the form of modulated light signals. The light signals efficiently propagate along the length of the optical fibers by a series of total internal reflections. Such optical transmission allows for transmission of data signals with very little loss of signal strength or integrity. By modulating optical signals across multiple wavelengths of light, a single optical fiber can transmit large amounts of data. However, optical fibers are relatively delicate. When subjected to excess physical strain or environmental damage, that ability of an optical fiber to efficiently transmit optical signals can be greatly diminished.

To avoid potential damage, optical fibers are often jacketed in protective sheaths to protect against exposure to environmental conditions. Such jacketing can also provide a level of protection against strain caused by kinking or over-bending. To further increase structural integrity, individually jacketed and unjacketed optical fibers are bundled together to create fiber-optic cables. Such fiber-optic cables are often used to transmit vast amounts of data in one-to-one, one-to-many and many-to-many communication systems.

### BRIEF DESCRIPTION OF THE DRAWINGS

FIG. 1A illustrates an example optical fiber distribution assembly.

FIG. 1B illustrates another example optical fiber distribution assembly.

FIG. 2A depicts a detailed view of an example optical fiber distribution assembly that includes multiple optical fiber distribution nodes.

FIG. 2B depicts a detailed view of another example optical fiber distribution assembly that includes multiple optical fiber distribution nodes having various shapes.

FIG. 3A includes a series of cross-sectional views that depict an example construction of an optical fiber distribution node.

FIG. 3B depicts a detailed view of internal components of an example optical fiber distribution node.

FIG. 4 is a flowchart of an example method for assembling an optical fiber distribution assembly.

FIG. 5A is a schematic of an example many-to-many optical fiber distribution node.

FIG. 5B depicts a simplified detail view of an example many-to-many optical fiber distribution node with strain relief elements.

FIG. 6 depicts an example stacked optical fiber distribution node with strain relief elements.

### DETAILED DESCRIPTION

The present disclosure describes devices and methods for distribution and alignment of optical fibers. For instance, various implementations of the present disclosure include an optical fiber distribution assembly for routing and aligning multiple optical fibers between various devices. Routing optical fibers between interconnected computing resource nodes and networking switches can be complicated. The convoluted physical routing, the density of fiber-optic connectors, the intricate sequencing of fiber couplings to the source and target devices, and other considerations all contribute to the complexity of implementing fiber-optic system topologies. Accordingly, optical fiber distribution assemblies described herein can be dimensioned and arranged to distribute and align optical fibers within a given computer system rack, row, or complex easily and cost effectively.

Various optical fiber distribution assemblies described herein can include features that decrease the cost and labor requirements involved in the manufacture of high density photonic routing connections. In addition, use of such optical fiber distribution assemblies can simplify the assembly of complex photonic communication topologies, such as in the installation of or upgrades to computing centers. In such implementations, the configuration and the optical fiber distribution assemblies can be custom built according to the intended installation.

In various example implementations, optical fiber distribution assemblies can include a source or input fiber-optic cable that includes a bundle of optical fibers. The input fiber-optic cable can include input ends of the optical fibers and a coupler for connecting each individual fiber within the bundle to a device, such as a photonic switching device.

At some point along its length, the fiber-optic cable can be coupled to an optical fiber distribution node. In various implementations, the optical fiber distribution node can include a housing assembly that can act as the structural support and/or framework for the node. The optical fiber distribution node housing assembly can include an input port through which the optical fibers can be threaded into the interior of the housing assembly. Once inside the housing assembly, the optical fibers can be grouped and routed to corresponding output ports in the housing assembly. As used herein, the terms “housing” and “housing assembly” can refer to any single or multiple part container or structure to which the fiber-optic cables can be coupled and through which the component optical fibers can be routed.

The selection of the groups of optical fibers and the position of the corresponding output port can be based on the location or intended location of at least one target device. For example, optical fibers that are to be routed to devices located on one side of the housing can exit through an output port disposed on a corresponding side of the housing, while optical fibers to be routed to devices located on another side of the housing can exit through another output port disposed on another corresponding side of the housing.

The interior of the housing can include elements for limiting the curvature of the optical fibers to help avoid breakage or loss in transmission efficiency. For example, once the optical fibers are routed within the interior cavity of the housing, the interior can be flooded with a potting material, such as an epoxy or resin that will set to immobilize and stabilize the positions of the optical fibers.

Optical fibers exiting the housing can be routed directly to corresponding target devices. In other example implementations, the optical fibers exiting one or more of the output ports can be bundled into intermediate or secondary fiber-optic cables. Those secondary fiber-optic cables can be then coupled to intermediate or secondary optical fiber distribution nodes to further distribute the optical fibers to devices disposed close to those nodes.

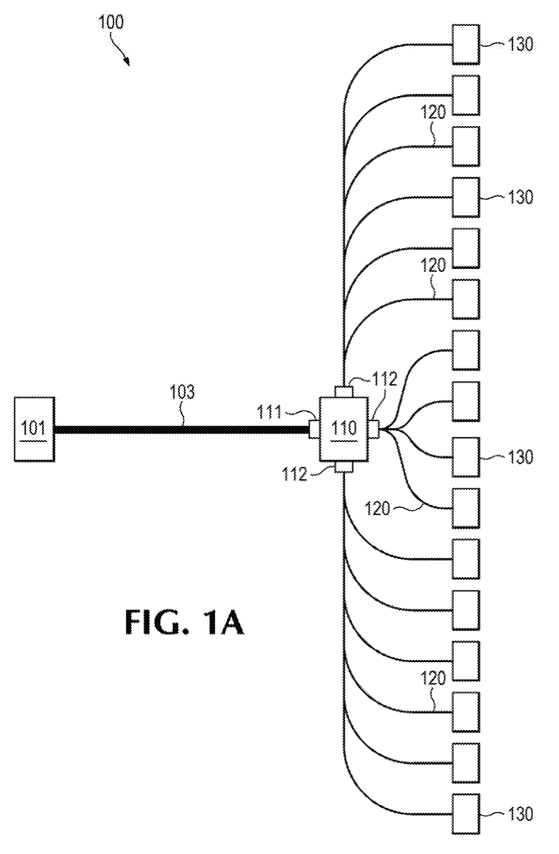

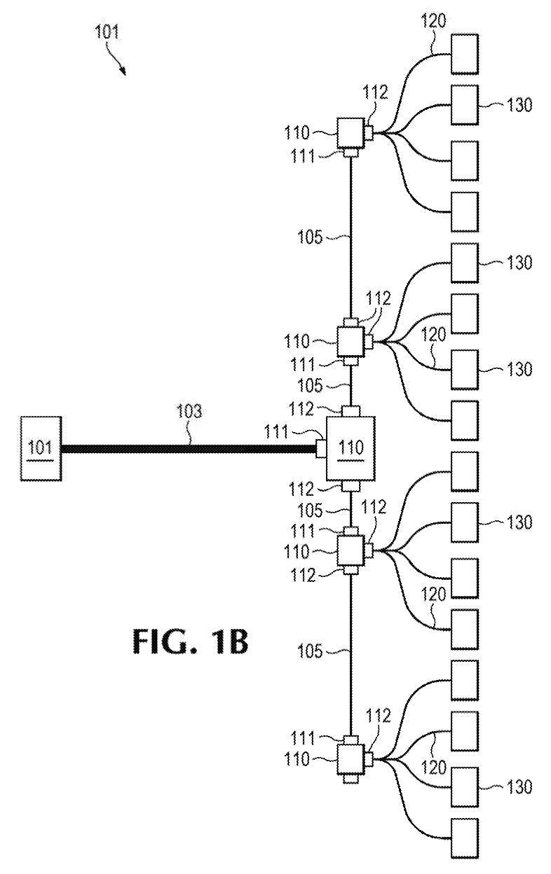

To further illustrate aspects and features of the present disclosure, various example implementations are described in additional detail in reference to the figures. For instance, FIG. 1A depicts a schematic of an example optical fiber distribution assembly 100. In the example shown, the optical fiber distribution assembly 100 can couple device 101 to multiple devices 130. For example, device 101 can be a source device, such as a photonic switch, that can transmit and/or receive photonic data signals to or from select devices 130 through corresponding component optical fibers 120 of fiber-optic cable 103. Devices 130 can also include photonic transmission and receiving capabilities. Accordingly, the optical fiber distribution assembly 100 can be used to route photonic signals between devices 130 and device 101 through the corresponding optical fibers 120.

In configurations like the example optical fiber distribution assembly 100, the fiber-optic cable 103 can be coupled to a photonic connection on device 101. To couple the fiber-optic cable 103 to device 101, at least some of the component optical fibers 120 can be coupled to a faceplate connector on device 101. The faceplate connector can couple corresponding optical signals from optical or photonic transmitters, receivers, or transceivers to component optical fibers 120.

As described herein, the fiber-optic cable 103 can include a bundle of multiple optical fibers 120 and other component structural and protective elements that give support and protection to the optical fibers. In one implementation, multiple optical fibers 120 can be protected by bundling them together loosely in sheath or jacket. In other examples, multiple optical fibers can be protected by arranging them on a plastic ribbon in groups (e.g., groups of 12), which can then be over-molded or covered with another plastic ribbon. In other examples, the optical fibers 120 can be protected by wrapping the fibers or molding a plastic jacket over the fibers.

In some implementations, the fiber-optic cable 103 can include a central core that provides tensile strength to the cable and an outer jacket that protects the internal components (e.g., optical fibers 120) of the cable. As described herein, each individual optical fiber 120 can be left bare or individually jacketed in a corresponding protective coating or jacket. The central core, the outer jacket, and/or the individual jackets of the optical fibers 120 can all work together to provide stiffness to the fiber-optic cable 103 to prevent kinks or drastic changes in curvature to prevent the optical fibers 120 from being strained or broken. Excess strain or breakage can reduce or destroy the ability of each individual optical fiber from being able to transmit a viable photonic signal.

The fiber-optic cable 103 can be coupled to the optical fiber distribution node 110 at the input port 111. The coupling of the fiber-optic cable 130 to the input port 111 can include inserting the fiber-optic cable 103 into an opening in the housing of the optical fiber distribution node 110. As such, the individual jacketed or unjacketed optical fibers 120 can be routed into the interior volume of the housing. Groups of the individual jacketed and/or unjacketed optical fibers 120 can be routed to a corresponding output port 112.

As shown in FIG. 1A, the group or output port 112 associated with a particular optical fiber 120 can be based on the physical location or configuration of the corresponding target device 130. For example, the output port 112 shown on the top of the housing of the optical fiber distribution node 110 can route the corresponding optical fibers 120 to the corresponding devices 130 in the upper portion of the array of devices. The output ports 112 shown on the right-hand side of the housing of the optical fiber distribution node 110 can route the corresponding optical fibers 120 to the corresponding devices 130 in the middle portion of the array of devices. Finally, the output port 112 shown on the bottom of the housing of the optical fiber distribution node can route the corresponding optical fibers 120 to corresponding devices 130 in the lower portion of the array of devices. In various implementations, the length of the individual optical fibers 120 can be dimensioned according to the placement of the target devices 130 relative to the optical fiber distribution node 110. For example, the length of optical fibers 120 going to the devices 130 at the ends of the array can be longer than the length of the optical fibers 120 routed to devices 130 in the middle of the array.

FIG. 1B illustrates an example optical fiber distribution assembly 101 that includes multiple optical fiber distribution nodes 110. In such implementations, groups of optical fibers can exit the initial or subsequent optical fiber distribution nodes 110 through the corresponding output ports 112 and be bundled into intermediate or secondary fiber-optic cables 105. For example, multiple racks of server computers can be associated or equipped with a corresponding optical fiber distribution node 110. The length of the fiber-optic cables 103 and intermediate fiber-optic cables 105 can be dimensioned to span the distances between the racks. The individual optical fibers 120 exiting the output port 112 of the associated optical fiber distribution node 110 can then be routed and coupled to the target devices 130 (e.g., server computers, photonic switches, routers, etc.) in that rack. Accordingly, each of the initial and subsequent optical fiber distribution nodes 110 route the component optical fibers 112 to corresponding locations associated with the corresponding optical fiber distribution node 110. In such implementations, the length of the individual optical fibers 120 exposed outside of a fiber-optic cables 103 or 105 can be reduced to help avoid potential damage.

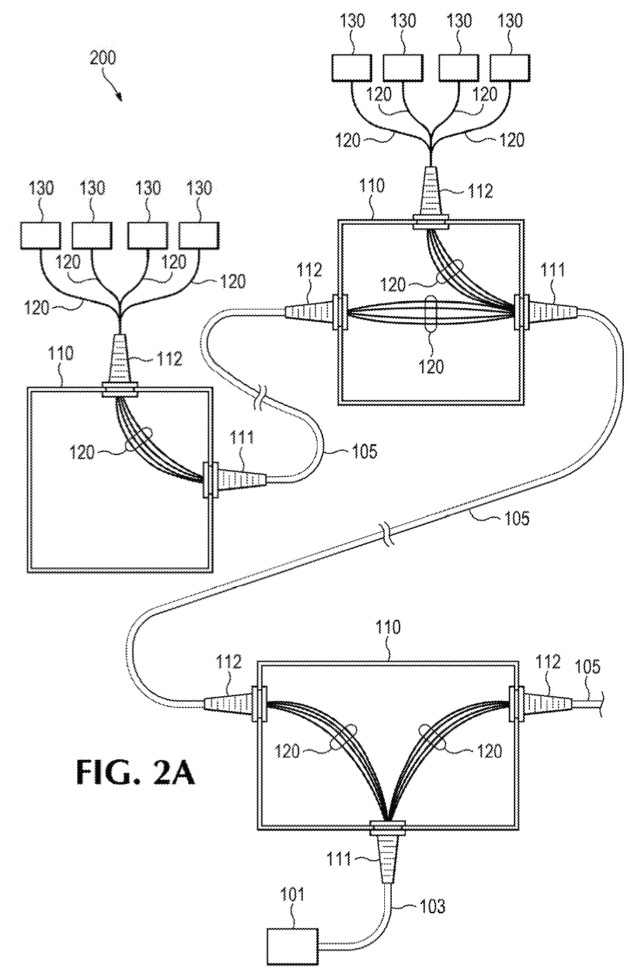

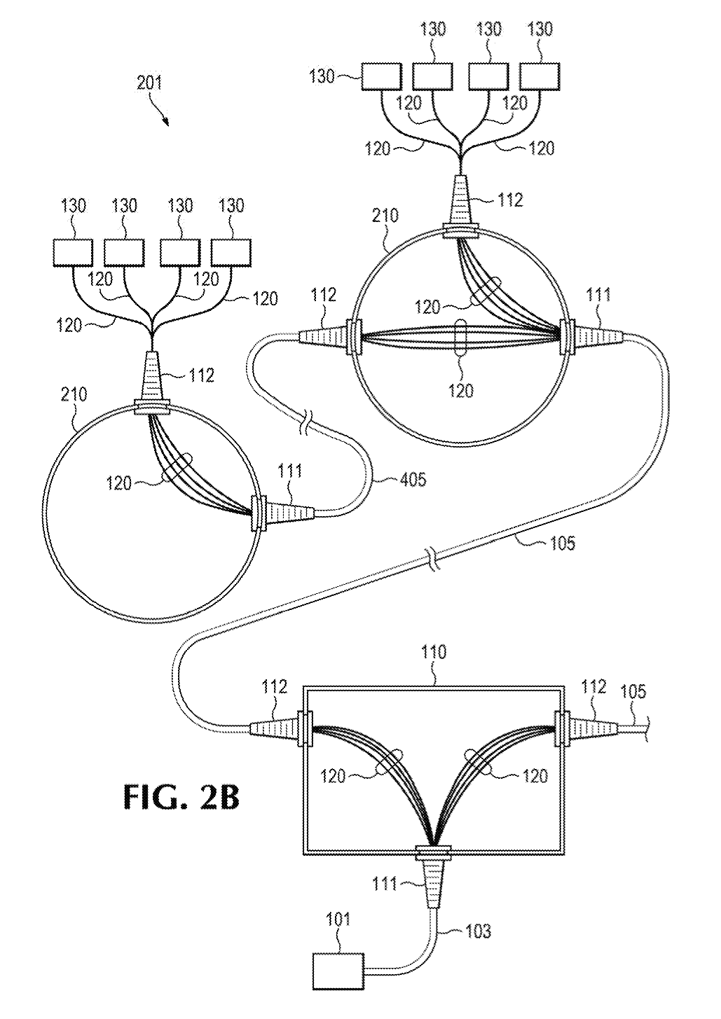

FIG. 2A depicts a detailed view of a portion of an example optical fiber distribution assembly 200 that includes multiple optical fiber distribution nodes 110. In the view of the optical fiber distribution assembly 200 of FIG. 2A, the optical fiber distribution nodes 110 are shown as being open (e.g., with no top cover) to show the routing of the individual optical fibers 120 within the housings.

In the example shown, a bundle of optical fibers 120 are coupled from a source device 101 to an initial optical fiber distribution node 110 through an input fiber-optic cable 103. In implementations like the one depicted in FIG. 2A, the input ports 111 and output ports 112 of the optical fiber distribution nodes 110 can include stress relief elements. The stress relief elements can include structures or fasteners that can prevent the input fiber-optic cable 103 and intermediate fiber-optic cables 105 from being pulled from their respective optical fiber distribution nodes 110. The stress relief elements can also limit the curvature of the fiber-optic cables 103 and 105 as well as the component optical fibers 120 when subjected to forces oblique to the housings.

Inside the housings of the optical fiber distribution nodes 110, the individual optical fibers 120 are grouped and routed to a corresponding output ports 112 such that the curvature of the optical fibers 120 is not less than a threshold radius. The threshold radius of curvature for the optical fibers 120 can be based on the optical characteristics of the component optical material(s) and the diameter or thickness of the optical fiber 120. The curvature of the optical fibers 120 within the housings of the optical fiber distribution nodes 110 can be controlled by the relative placement and angle of the input and output ports 111 and 112 and/or the dimensions and/or shape of the optical fiber distribution nodes 110. For example, output ports 112 disposed at 90 degrees relative to the input ports 111 can maintain a curvature of the optical fibers 120 greater than the threshold radius by placing them far enough apart from one another.

The example optical fiber distribution assembly 200 shown in FIG. 2A can be specific to a particular installation. For example, the source device 101 may be at a location at a particular distance from the installation of a rack of photonic communication devices 130. In such implementations, the fiber-optic cable 103 of a particular length that can include medium or long haul characteristics that help avoid damage to the component optical fibers 120. The first optical fiber distribution node 110 (e.g., the optical fiber distribution node to which the incoming fiber-optic cable 103 is coupled), can split the component optical fibers 120 into two groups. One group of optical fibers 120 can be routed to a first set of secondary optical fiber distribution nodes 110, while the other group can be routed to a second set a secondary optical fiber distribution node 110. In FIG. 2A, only one set of secondary optical fiber distribution nodes 110 are illustrated.

The length of the secondary fiber-optic cables 105 can be based the distance or position of corresponding target devices 130 relative to the initial optical fiber distribution node 110. For each location of target devices 130, a corresponding group of optical fibers 120 can be routed to a corresponding output port 112. The individual optical fibers 120 can then be routed externally to the target devices 130. Optical fibers 120 not intended to be coupled to target devices 130 local to a particular optical fiber distribution node 110, can be routed to another corresponding output port 112 and bundled in another secondary fiber-optic cable 105 and routed to subsequent optical fiber distribution nodes 110. Accordingly, individual optical fibers 120 can be peeled off and routed to a corresponding output port 112 in successive optical fiber distribution nodes 110.

FIG. 2B illustrates that the shape and dimensions of the optical fiber distribution nodes, as well as the relative placement of the component input and output ports 111 and 112 can vary. In the particular example optical fiber distribution assembly 201 shown in FIG. 2B, the two secondary optical fiber distribution nodes 210 include a cylindrical or spherical housings. In such implementations, the output ports 112 can be disposed anywhere in the housing of the distribution nodes 210. As in other examples, the input ports 111 and output ports 112 can include stress relief elements.

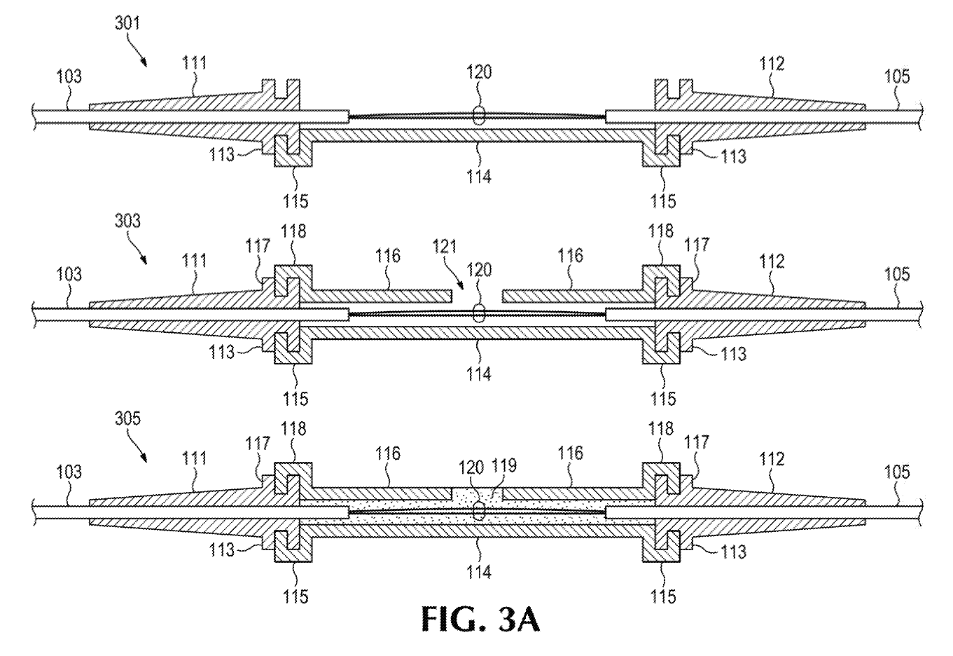

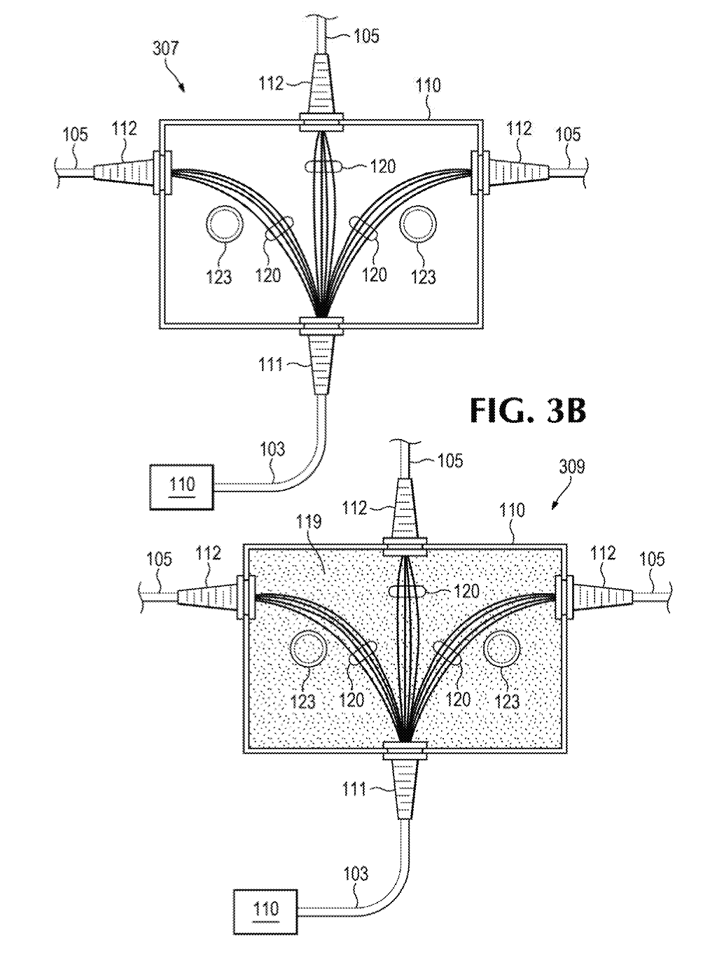

FIG. 3A depicts cross-sectional views of an example optical fiber distribution node 110 in various states of assembly. In view 301, one part of the housing 114 (e.g., the bottom portion) is shown in cross-section. The part of the housing 114 can include coupling elements 115 for connecting the corresponding coupling elements 113 of ports 111 and 112. In the example shown, the coupling elements include corresponding C-shaped elements that can nest within one another. The fiber-optic cable 103 can be threaded through the port 111. In the example shown, the port 111 includes a cone shaped curvature restricting element made of a flexible material (e.g., plastic, rubber, or the like).

Between the input port 111 and the output port 112, the jacket of the fiber-optic cable 130 and/or each individual optical fiber 120 can be removed. For example, individual optical fibers 120 can be bare or jacketed in individual protective coatings or sheaths. As described herein, the optical fibers 120 can be routed to a corresponding output port 112. Beginning in the interior volume of the optical fiber distribution node 110, the interior of the stress relief element of the output port 112, or the exterior of the output port 112, the various individual optical fibers 120 can be re-bundled into a secondary or intermediate fiber-optic cable 105. While only one output port 112 is depicted in the various views of FIG. 3A, the optical fiber distribution node 110 can include multiple output ports 112.

Once all of the individual optical fibers 120 are routed to the corresponding output ports 112, a corresponding cover element, part 116, of the housing can be coupled to the input port 111, the output ports 112, and/or the bottom 114 to create an interior volume, thus enclosing the individual optical fibers 120 in the optical fiber distribution node 110, as shown in view 303. For example, part 116 can be a top or a lid that can be joined with the bottom housing 114 to create an enclosure around the optical fibers 120 and further engage the input port 111 and output ports 112 at the corresponding coupling elements 117 and 118. In various implementations, part 116 can be adhesively joined, welded (e.g., heat or ultrasonic welding), clipped, screwed, or otherwise fastened or attached to part 114 and/or ports 111 and 112. In some implementations, part 116 and part 114 can include features that snap together. In the particular example shown, part 116 of the housing can include an access port or opening 121.

As shown in view 305, a potting material 119 can be injected through access port 121 into the volume between part 116 and 114. The rate of injection can be controlled so as to reduce the possibility of the flow of the potting material 119 disturbing or displacing the optical fibers 120. The potting material 119 can include any adhesive, resin, epoxy, silicone, or the like, that can be injected into the interior volume of the optical fiber distribution node 110 as a liquid or gel and cured to form a solid or semi-solid around the individual optical fibers 120. In some implementations, the potting material 119 can include an ultraviolet (UV) light curable material or other fast-setting material. Accordingly, potting material 119 be cured using ultraviolet (UV) light or otherwise induced to set quickly to increase the speed of assembly in high volume production.

FIG. 3B depicts a top cross-sectional view of an example optical fiber distribution node 110 according to various implementations of the present disclosure. In view 307, the optical fiber distribution node 110 is shown without the potting material 119. View 307 also depicts elements 123. Elements 123 can be included in the bottom part 114 or the top part or cover element 116 of the housing of the optical fiber distribution node 110. In some implementations, elements 123 can include fill ports that can provide access for injecting potting material 119. Such fill ports can be used in a manufacturing environment or in the field for filling the volume of the optical fiber distribution node 110 with potting material 119 at pressures low enough to avoid damaging or kinking the optical fibers 120. In other implementations, the elements 123 can include standoff elements. Such standoff elements can include cylindrical or other structurally shaped elements that can span the volume between the bottom part 114 and the top part 116 to prevent the housing from being crushed or compressed.

View 309 depicts a top cross-sectional view of the example optical fiber distribution node 110 similar to that in view 307 but with the potting material 119 in place and encasing the optical fibers 120.

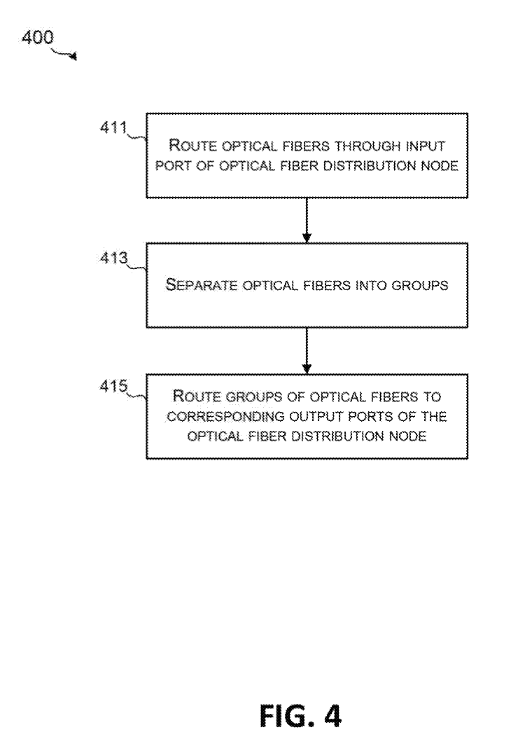

FIG. 4 is a flowchart of an example method 400 for assembling an optical fiber distribution node 110, according to various implementations of the present disclosure. The method can begin at box 411, in which the optical fibers 120 of a particular fiber-optic cable 103 are routed through the input port 111 in the housing of an optical fiber distribution node 110. As described herein, the housing may be a portion of the housing that makes up the exterior and or structure of the optical fiber distribution node 110 such that the interior is open and accessible to a user. For example, the housing may be the bottom portion 114 of the distribution node 110.

With ends of the individual optical fibers 120 introduced into the interior of the housing, the optical fibers 120 can be separated into groups at box 413. At box 415, the groups of optical fibers 120 can be routed to the corresponding output ports 112 of the optical fiber distribution node 110.

The creation of the groups can be based on the location of the intended target devices 130 relative to the intended placement of the resulting optical fiber distribution node 110. For example, a particular optical fiber distribution node may include at least one output port 112 that will end up being installed at or near a particular rack of server computers. Each of the optical fibers intended to be coupled to those server computers can be grouped and routed to that corresponding output port 112.

Grouping the optical fibers 120 can be achieved by illuminating the input end of those optical fibers 120 with a particular wavelength of light while other optical fibers 120 within the input fiber-optic cable 103 remain dark or are illuminated with a different wavelength of light. In some implementations the wavelengths of light used to illuminate a group of optical fibers can include any wavelength in the visual spectrum. For example, the wavelengths of light can include red, green, blue, white, or other colors of light that are easily distinguishable from one another. Accordingly, the optical fibers 120 can be sorted using the color of light being emitted from the output end of the optical fibers. As such, colored light coded optical fibers 120 can be associated with and routed to a particular port.

The color coding can include both visible light (e.g., wavelengths clearly visible to human users) and invisible light (e.g., wavelength detectable by non-human sensors). In some implementations, the illumination can include an optical signal to confirm proper routing and fiber integrity. While routing the optical fibers 120, care can be taken to route the optical fibers 120 so as to reduce the curvature of the optical fibers 120 to avoid excess strain or breakage.

In some implementations of method 400, the optical fiber distribution node 110 can be closed by coupling the bottom part of the housing 114 with a top part 116 (e.g., a cover element). With the top part 116 in place, the housing of the optical fiber distribution node 110 can secure strain relief elements at ports 111 and/or 112. In some implementations, a potting material 119 can be injected through an opening in the housing, such as openings 121 or fill port element 123, into the interior volume of the optical fiber distribution node 110 to stabilize the optical fibers 120 therein.

In various implementations, the routing of the optical fibers and assembly of the optical fiber distribution nodes 110 can be sufficiently simple to allow on-site construction of the optical fiber distribution assemblies in the field. Accordingly, optical fiber distribution assemblies can be constructed in the field as needed to facilitate installations of large optical fiber communication topologies. As such, various implementations of the present disclosure allow for low-cost on-site manufacture of custom optical fiber distribution assemblies. Custom optical fiber distribution assemblies can reduce costs and more efficiently use optical fibers and fiber-optic cable than other methods used to create photonic communication connections.

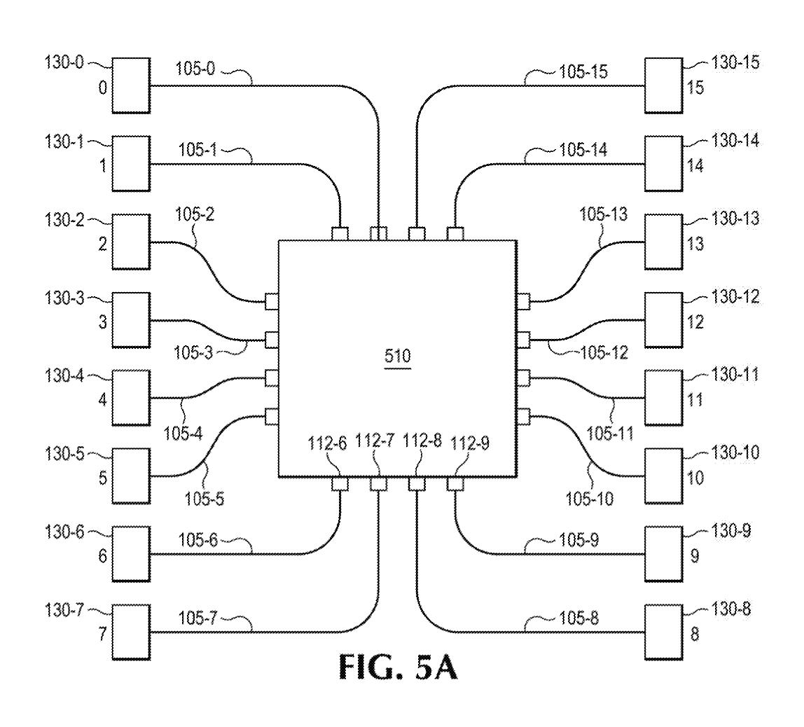

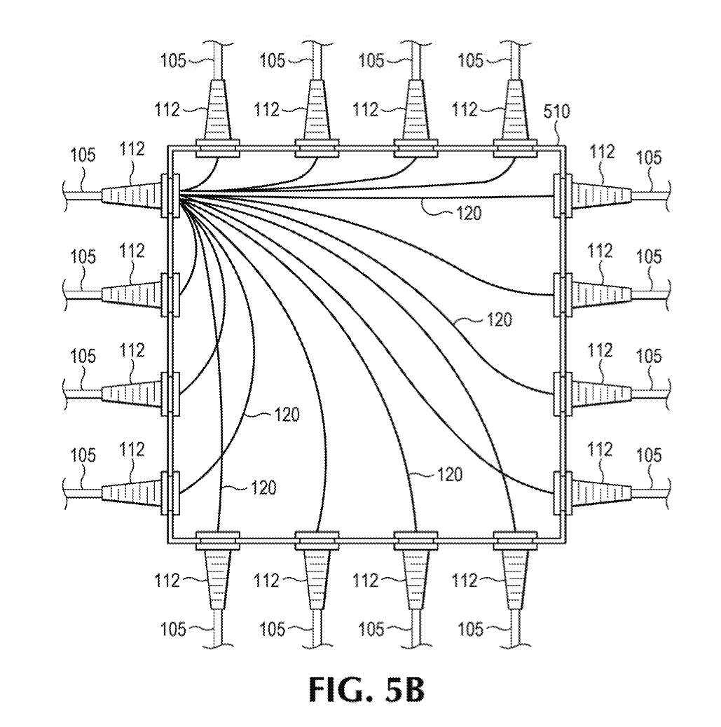

FIG. 5A depicts a schematic of an example many-to-many optical fiber distribution node 510, according to implementations of the present disclosure. As shown, the optical fiber distribution node 510 can include ports 112 for receiving corresponding fiber-optic cables 105 that can each include one or more component optical fibers 120. Each of the fiber-optic cables 105 can be dedicated to a particular corresponding device 130. The ports 112 can simultaneously be an input port and an output port. For example, any device 130 can be communicatively coupled to any and all other devices 130 through corresponding optical fibers 120 routed through the optical fiber distribution node 510. Accordingly, each of the fiber-optic cables 105 and/or the component optical fibers 120 (not shown in FIG. 5A) can carry photonic signals in both directions (e.g., each port 112, fiber-optic cable 105, and optical fiber 120 can be bidirectional).

FIG. 5B illustrates a simplified internal view of an example many-to-many optical fiber distribution node 510, according to various implementations of the present disclosure. For clarity, only the optical fiber connections between one port 112 and other ports 112 are shown. Accordingly, the optical fibers 120 can represent the output connections from the one port 112 to all other ports 112, or, alternatively, the input connections from all ports 112 to the one port 112. Each of the ports 112 can be connected to all other ports 112 by a corresponding optical fibers 120, similar to configuration shown.

As shown, the housing of the distribution node 510 can include coupling elements for receiving and coupling to ports 112 that include stress relief elements. The individual component optical fibers 120 of an input fiber-optic cable 105 can be routed to the corresponding output ports 112. The interior volume of the distribution node 510 can also be stabilized using a potting material, such as a potting material 119 described herein.

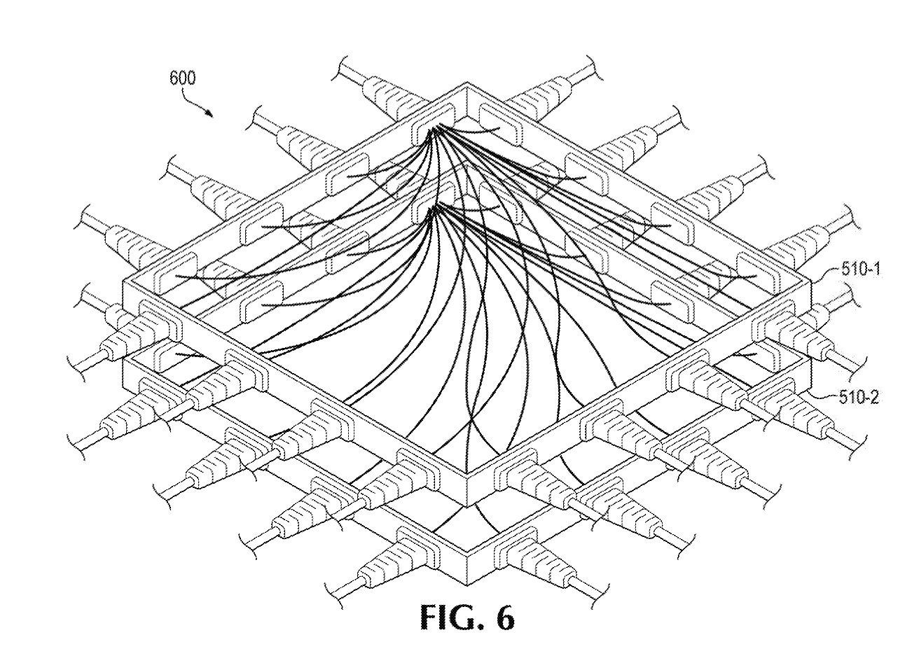

The many-to-many optical fiber distribution node 510 can be stacked on additional many-to-many optical fiber distribution nodes 510 to create a high density many-to-many optical fiber distribution node, such as the many-to-many optical fiber distribution node 600 illustrated in FIG. 6. For example, if each port 112 and 111 included 100 optical fibers, then 1600 optical fibers would cross in the interior of the fiber-optic distribution node 510. To reduce the complexity of any one particular optical fiber distribution node 510 in the stack 600, each of the optical fiber distribution nodes 510 can include a subset of the optical fiber 120 connections. The reduction of the number of optical fibers 120 in any one particular optical fiber distribution node 510 can simplify the manufacturing process and produce good yield without specialized manufacturing equipment.

In some implementations, routing of the optical fibers 120 in the fiber-optic distribution node 510 can be laid out on a wiring harness loom with little modification. Accordingly, implementations of the present disclosure can provide methods and optical fiber distribution assemblies that allow for routing optical fibers with reduced requirement for precise optical fiber placement. As such, the speed of manufacturing such assemblies can be increased and the cost decreased.

These and other variations, modifications, additions, and improvements may fall within the scope of the appended claims(s). As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. An optical fiber distribution node comprising:
a housing assembly;
an input port in the housing assembly;
an input optical fiber cable coupled to the input port and comprising a plurality of optical fibers;
a first subset of the plurality of optical fibers routed from the input port through a first output port in the housing assembly; and
a second subset of the plurality of optical fibers routed from the input port through a second output port in the housing assembly.

2. The optical fiber distribution node of claim 1 wherein the first subset of the plurality of optical fibers and the second subset of the plurality of optical fibers are routed through an interior volume of the housing assembly.

3. The optical fiber distribution node of claim 2 wherein the interior volume of the housing assembly comprises a potting material to stabilize the first subset of the plurality of optical fibers and the second subset of the plurality of optical fibers.

4. The optical fiber distribution node of claim 1 wherein the first subset of the plurality of optical fibers comprises a first set of corresponding optical fiber lengths and the second subset of the plurality of optical fibers comprises a second set of corresponding optical fiber lengths.

5. The optical fiber distribution node of claim 1 wherein each optical fiber in the first subset of the plurality of optical fibers is individually jacketed.

6. The optical fiber distribution node of claim 1 wherein the first subset of the plurality of optical fibers is bundled into a secondary optical fiber cable coupled to the first output port to an input port of a secondary housing assembly.

7. A method comprising:
coupling a fiber-optic cable comprising a plurality of optical fibers to an input port of a distribution node housing; and
routing a subset of the plurality of optical fibers from the input port to an output port through a volume defined by the distribution node housing.

8. The method of claim 7 wherein routing the subset of the plurality of optical fibers comprises selecting the subset of the plurality of optical fibers based on a plurality of locations of corresponding target devices.

9. The method of claim 7 wherein routing the subset of the plurality of optical fibers comprises illuminating input ends of the subset of the plurality of optical fibers with light indicating an association with the output port.

10. The method of claim 7 further comprising attaching a cover element to the distribution node housing to enclose the subset of the plurality of optical fibers.

11. The method of claim 10 further comprising filling the volume defined by the distribution node housing and the cover element with a potting material to stabilize the subset of the plurality of optical fibers

12. An optical fiber distribution assembly comprising:
a first distribution node housing comprising an input port and a plurality of output ports;
an input bundle of optical fibers comprising a plurality of optical fibers, wherein subsets of the plurality of optical fibers are routed to corresponding output ports in the plurality of output ports through an interior volume defined by the first distribution node housing based on physical locations of corresponding target devices; and
a plurality of output bundles of optical fibers comprising the subsets of the plurality of optical fibers and coupled to corresponding output ports in the plurality of output ports.

13. The optical fiber distribution assembly of claim 12, wherein an output bundle in the plurality of output bundles is coupled to a second distribution node housing in which each optical fiber corresponding to the one output bundle is routed to corresponding output ports in a plurality of output ports in the second distribution node housing through an interior volume defined by the second distribution node housing.

14. The optical fiber distribution assembly of claim 12, wherein each of the plurality of optical fibers, the input bundle, and the plurality of output bundles are dimensioned based on a physical location of a source device or the physical locations of the corresponding target devices.

15. The optical fiber distribution assembly of claim 12, wherein the first distribution node housing comprises a potting material disposed in the interior volume to stabilize the subsets of the plurality of optical fibers.
